(19) United States
(12) Patent Application Publication
(10) Pub. No.: US 2017/0263160 A1
(43) Pub. Date: Sep. 14, 2017

(54) DO-IT-YOURSELF TAXIDERMY KIT

(71) Applicant: MEMARK TECHNOLOGIES, INC., HUNTSVILLE, AL (US)

(72) Inventor: MARK HOSE, HUNTSVILLE, AL (US)

(21) Appl. No.: 15/432,448

(22) Filed: Feb. 14, 2017

Related U.S. Application Data
(60) Provisional application No. 62/306,457, filed on Mar. 10, 2016.

(51) Int. Cl. G09B 23/36; G09B 23/30

(52) U.S. Cl. CPC G09B 23/36; G09B 23/30

(57) ABSTRACT

A do-it-yourself taxidermy kit includes a three-dimensional animal form approximating the head and neck of a deer, a fabric body covering imprinted with a photorealistic image of the animal's hide and constructed to snugly enclose the form. The kit may advantageously comprise means for mounting deer antlers to the head portion of the animal form.

### CROSS-REFERENCE TO RELATED APPLICATIONS

The present application derives priority from U.S. provisional application No. 62/306,457 filed 10 Mar. 2016, which is incorporated by reference as if fully set forth herein.

### BACKGROUND OF THE INVENTION

Field of the Invention

The apparatus set forth herein relates generally to Do-It-Yourself (DIY) taxidermy, and in particular, to a kit for enabling DIY taxidermy.

Description of the Problem and Related Art

Traditional taxidermy of antlered deer, or bucks, is expensive and labor-intensive. It involves skinning the deer (removing the hide), fleshing (removing the meat from the hide), and tanning (adding chemicals to the hide) to preserve the perishable deer hide. These processes are labor-intensive which drives up costs. Once the hide is preserved it is applied to a man-made three-dimensional (3D) animal form, then the antlers are mounted, followed by intricate and artistic finishing work on the eyes and nose areas. Glass eyes are typically installed just prior to applying the deer hide; at which time the taxidermist uses clay and paint to blend the glass eyes into the preserved deer hide producing a life-like deer mount.

There are several alternatives for those hunters that do not wish to deal with the time and expense associated with traditional full-up taxidermy. One such alternative is to mount the antlers onto a simple plaque and cover the bone that bridges the antlers with leather or felt material. Another alternative is known as a European mount whereby the antlers are left intact on the skull; and the entire skull with antlers attached are cleaned by various methods such as boiling or use of insects (ants and beetles). Another alternative includes a molded 3D resin form that hosts the actual antlers, providing a modest replica of the deer hide via texture in the molded 3D form.

U.S. Pat. No. 8,512,045 to Bittner, teaches molding a 3D animal form with a textured surface to replicate an appearance of fur. However, while molding the fur into the form attempts to replicate a texture, it does not replicate the visual appearance of the incredibly detailed color variations observed on a natural animal hide, such as that of a deer. A close inspection of a deer hide, for example, reveals a myriad of color variations per square inch. Individual hairs may be any of a variety of colors to include white, tan, red, black, and hundreds of color variations in between.

Another example is U.S. Pat. No. 8,162,670 to Hacke, which discloses covering a 3D animal form with artificial hair or fur. Although, artificial hair (or fur) can replicate the texture of a deer hide, it cannot replicate the visual appearance of the incredibly detailed color variations observed on a natural deer hide, again suffering the same shortcoming as Bittner. Furthermore, the fur or hair cannot be dyed in any appreciable way to produce an effective visual replica of a natural deer hide.

The kit described below removes the labor-intensive tasks of skinning, fleshing, and tanning of the hide as well as the intricate finishing work on the eyes and nose areas. The kit applies photorealistic printed covers to 3D animal forms, followed by the installation of molded prefabricated eyes and nose appliances. Ear appliances can be installed and use the same printed cover concept as the printed covers used on the main animal forms. The eye and nose appliances serve a second purpose as they actually help register the printed cover strategically to the 3D form. Photorealistic covers provide a compelling realism, replicating the visual appearance of the incredibly detailed color variations observed on a natural deer hide. Furthermore the photorealistic covers can trick an observer into thinking that the hair observed on the printed covers is real and therefore giving the appearance of a traditional mounted trophy head.

### SUMMARY

To overcome the shortcomings of the current art, a DIY taxidermy kit is provided which in general comprises a three-dimensional animal form, and a fabric body covering imprinted with a photorealistic image of the animal's hide. The covering comprises a resilient fabric with sufficient elasticity such that when properly constructed, the covering snugly overlays the form.

In one embodiment, the kit provides left and right ear appliances that may be attached at the appropriate places on the covered form, as well as left and right eye appliances and a nose appliance.

In another embodiment in which the animal is a deer, the kit provides means for attaching a set of deer antlers to the head of the covered form.

In some embodiments, the fabric is imprinted using a direct-to-garment fabric printing technique. Further, the photorealistic image may be generated as a composite of digital images of an animal hide, thus providing a realistic depiction of such hide.

It will be understood that for the purposes of the above summary, certain aspects, advantages, and novel features are described. However, it is to be understood that not necessarily all such advantages may be achieved in accordance with any one particular embodiment. Thus, apparatuses or methods claimed may be embodied or carried out in a manner that achieves or optimizes one advantage or group of advantages as taught herein without necessarily achieving other advantages as may be taught or suggested herein.

### BRIEF DESCRIPTION OF THE DRAWINGS

The kit is described with reference to the accompanying drawings. In the drawings, like reference numbers indicate identical or functionally similar elements. Additionally, the left-most digit(s) of a reference number identifies the drawing in which the reference number first appears.

FIG. 1 illustrates components of an exemplary DIY taxidermy kit according to the teachings herein;

FIG. 2A is a view of an exemplary flat pattern printed cover;

FIG. 2B illustrates an assembled trophy showing one possible location of a front seam for the cover fitted upon the body form according to one exemplary embodiment;

FIG. 3A is a front perspective view of a 3D animal form according to an embodiment of the DIY taxidermy kit;

FIG. 3B is a rear perspective view of the form presented in FIG. 3A;

FIG. 4A is a front perspective view of a deer trophy assembled using an exemplary DIY taxidermy kit;

FIG. 4B is a rear perspective view of the assembled trophy of FIG. 4A;

FIG. 5A shows a flat pattern of a printed ear cover;

FIG. 5B is a view of a completed ear cover using the pattern shown in FIG. 5A;

FIGS. 6A & 6B & 6C show an ear cover over a three-dimensional ear form according to an alternative embodiment;

FIGS. 7A & 7B show an exemplary eye appliance;

FIGS. 8A & 8B show an exemplary nose appliance;

FIG. 9 is an exploded view highlighting an exemplary removable antler mounting block;

FIG. 10 is a detailed view of the mounting block of FIG. 9;

FIGS. 11A & 11B show a foam and a printed toupee, respectively, for use in mounting the antlers;

FIGS. 12A & 123 depict installation of the toupees installed;

FIG. 13A presents an exemplary ear form for use in another alternative embodiment;

FIG. 13B depicts an exemplary ear cover for use in the same alternative embodiment as that of FIG. 13A, the cover turned inside out such that the inner surface thereof is displayed;

FIG. 13C illustrates securing the ear cover of FIG. 13B to the ear form of FIG. 13A;

FIG. 14 is a view of an exemplary flat pattern printed cover according to yet another alternative embodiment;

FIG. 15 is a lower, front perspective view of a two-piece 3D animal form according to another alternative embodiment;

FIGS. 16 A & B show a view of an exemplary two-piece flat pattern printed cover;

FIG. 17A shows a two-piece body cover applied to a two-piece body form;

FIG. 17B show an assembled two-piece body form covered by a two-piece body cover; and

FIG. 18 is a view of an exemplary flat pattern printed cover according to yet another alternative embodiment.

### DETAILED DESCRIPTION

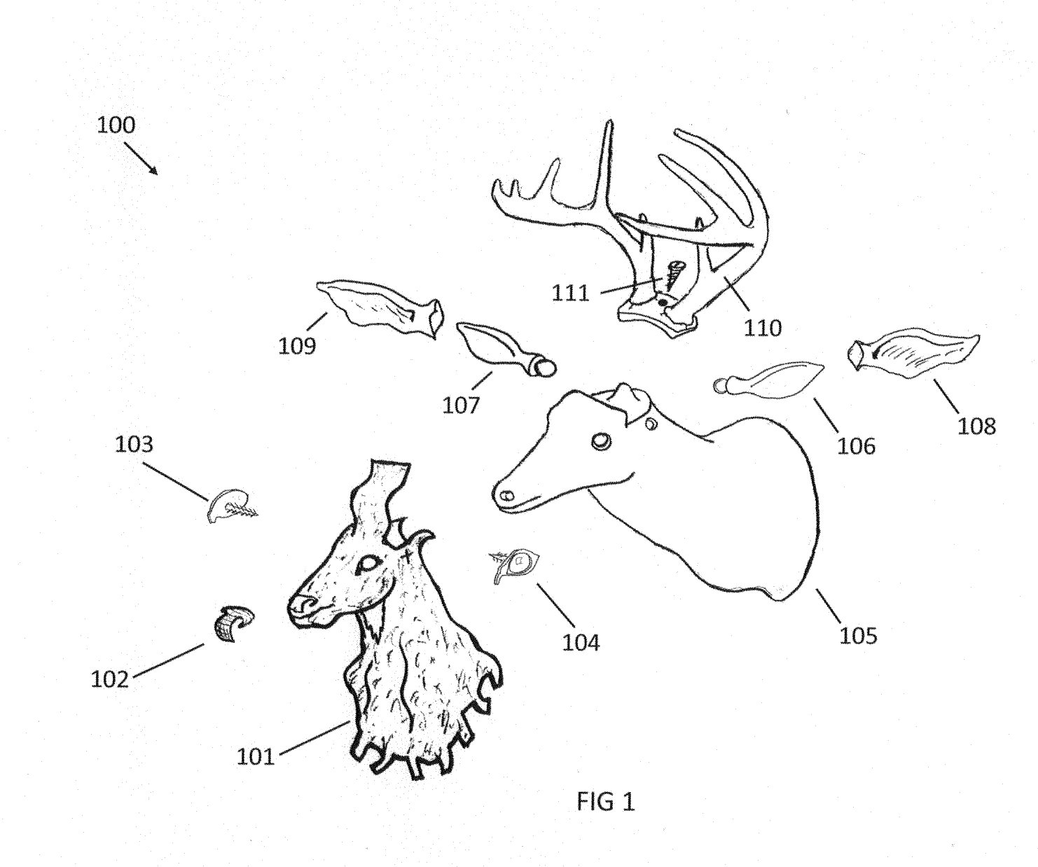

The various embodiments of the DIY taxidermy kit and its advantages are best understood by referring to FIGS. 1 through 18 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least ore embodiment. Thus, the appearance of the phrases “in one embodiment,” “in another embodiment,” or variations thereof in various places throughout the specification are not necessarily all referring to its respective embodiment.

With reference first to FIG. 1, an exemplary DIY taxidermy kit 100 as illustrated comprises a main animal body form 105, as that term is understood in taxidermy art, that is covered by a fabric body cover 101 with the cover bearing a photorealistic quality image that mimics the appearance of an animal's hide. The kit 100 further comprises a nose appliance 102 and left and right eye appliances 103 & 104 that may be applied after the body cover 101 is applied to the body form 105, whereby the nose appliance 102 and the eye appliances 103 & 104 also serve to register, or guide, the photorealistic body cover 101 on the main form 105. The DIY taxidermy kit 100 further comprises left and right 3D ear forms 106 & 107 that are covered with corresponding photorealistic printed ear covers 106 & 100 and are eventually attached to the body form 105 after the body form 105 has been covered with the body cover 101. The kit 100 includes means of attaching antlers 110 to the main form 105 using, in one embodiment, one or more screws 111. The body cover 101 comprises a shape to allow for the printed fabric to cover the skull plate between the antlers 110 and further provide covering around the left and right sides of the mounted antlers 110.

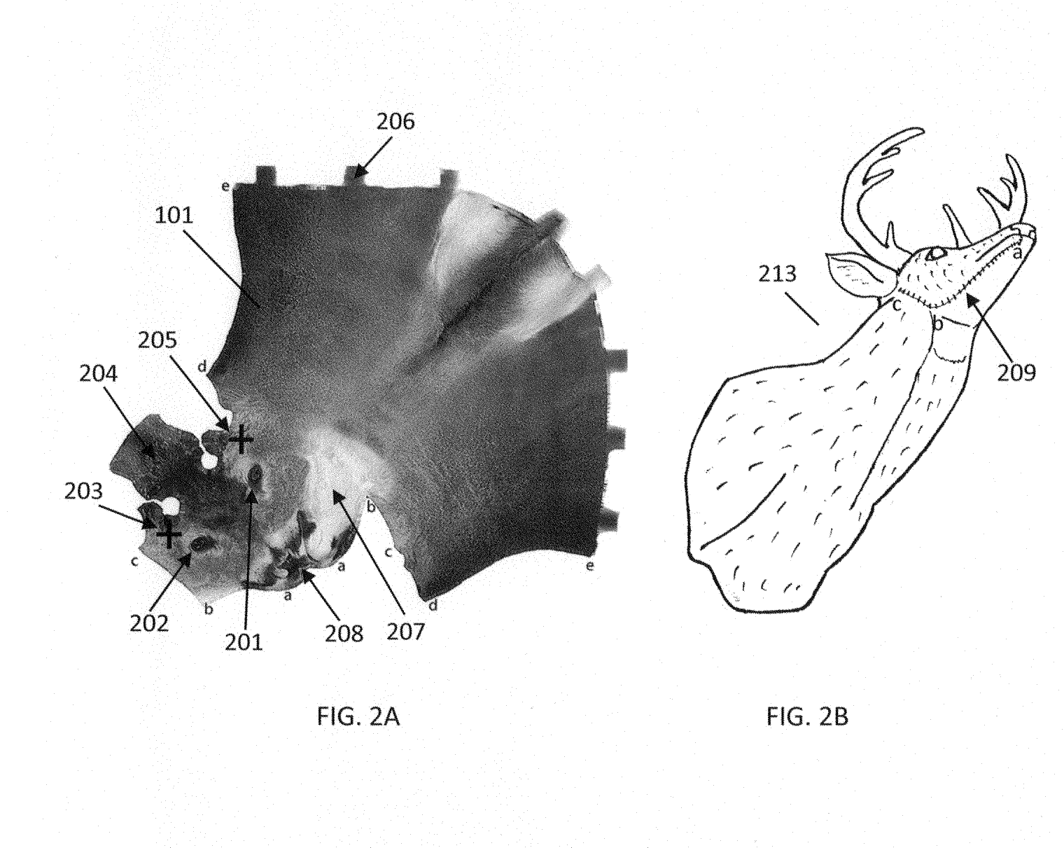

FIG. 2A shows a flat pattern of the body cover 101 with photorealistic printing whereby multiple printed features such as the eyes 201 & 202, the throat 207, and the nose 208 can be used to apply the cover 101 to the proper corresponding points on the body form 105 during assembly. Additional assistance in the registration of the main cover is provided by fiducial markings 203 & 205 which also register the location for the installation of the ear appliances 106 & 107. The body cover 101, in one embodiment, can be printed to fabric using direct-to-garment (DTG) printing, and in another embodiment be created using screen printing or sublimation printing methods. It should be mentioned that the eyes 103, 104 and the nose 102 appliances can be omitted if the eyes and nose are otherwise printed on the body cover 101.

The body cover 101 may be printed with a printer of suitable resolution which may be as low as 50 dots-per-inch (DPI). However, it will be appreciated that to provide a photorealistic image on the body cover 101, the printer should have suitably high resolution. Suitable high resolution printers for this application are typically capable of resolution ranging from about 150 DPI to about 1400 DPI. Particularly resolutions of about 300 DPI, about 600 DPI, and about 1200 DPI can produce an acceptable high quality image conveying realism that tricks the eye. Those skilled in the relevant art will appreciate that the fabric used for the body cover 101 may limit resolution. For example, it is possible that the highest resolution achievable on a stretch fabric is limited to about 300 DPI.

In yet another embodiment, body cover 101 may be created using a 3D scanning process in combination with photogrammetry, to apply a photorealistic image of an animal hide on a flat piece of fabric. One such scanning process, used for live or moving objects, employs an array of multiple cameras with lenses of various focal lengths. Images are taken simultaneously from many angles. Using photogrammetry, software determines points of commonality between images. Camera locations are known so points of commonality recognized by at least three camera images determine a point in space. As this computation is completed millions of times a dense point cloud is formed which accurately describes the geometry of the subject photographed, in this case, an animal head. The point cloud is transformed in software into a 3D mesh. The software takes the best of the images from each angle and places them on the surface of the mesh geometry. Because all the images are taken simultaneously, and because great care is taken to create the most even lighting possible, the software can create a 3D image which looks very well blended and uniform.

A second photography pass is made taking a series of close-up images in the same very even lighting scenario. These more detailed images are rendered on a 3D digital model using the original lower resolution images as a guide. Following a flat pattern such as the one shown in FIG. 2A, the surface mesh, including color texture is separated along mesh lines to create a flattened image. An example of such a technique is used by Captured Dimensions, LLC, located in Frisco, Tex. For a stationary object, a hand-held 3D scanner may be used.

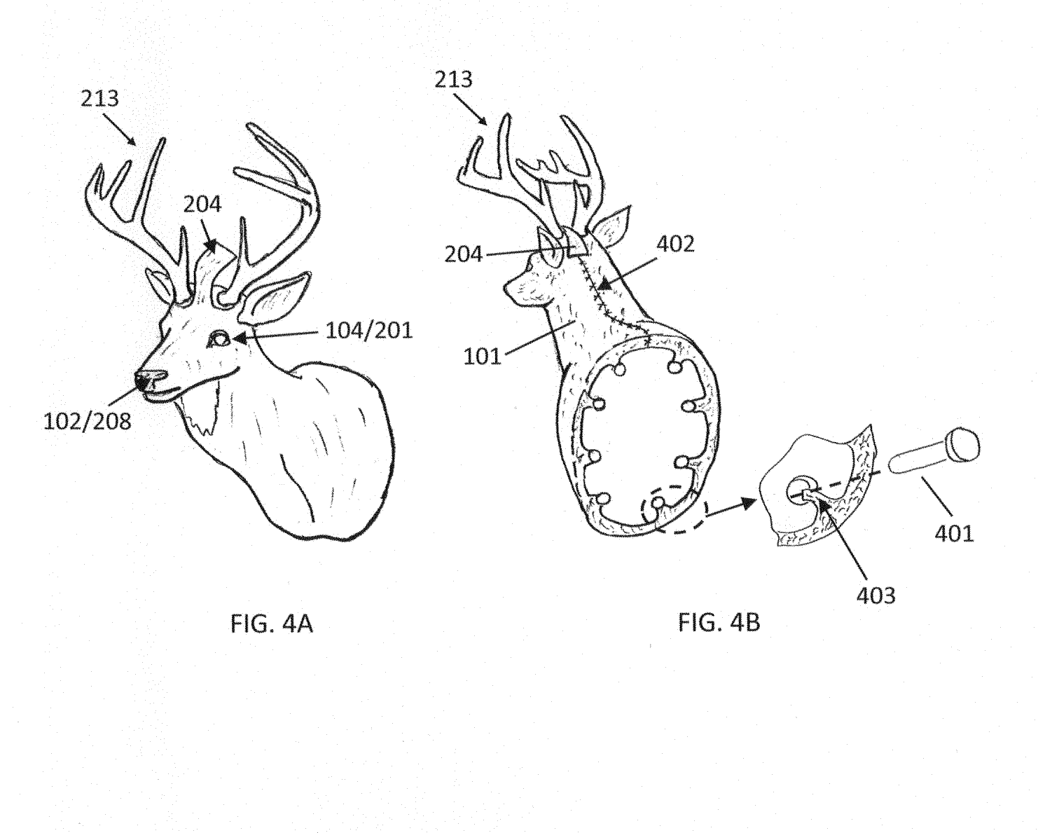

The body cover 101 is preferably formed into the pattern presented in FIG. 2A to minimize visible seams and to also optimize its fit to the body form 105. The outline of the flat pattern shown in FIG. 2A is fashioned to disguise seams resulting from constructing the cover 101. The annotations “a”, “b”, and “c” show the points along the edges of the flat pattern surrounding the head of the animal image that are mated together bringing opposing edges of the pattern together. The edges are fastened to one another to form a sack to slide over the body form 105. When the trophy 213 (FIG. 2B) is assembled, the resulting seam 209 is disposed under-side of the chin in a generally white area of the deer hide image and along the contour of the jaw that leads up to the ear. Similarly, mating points “d” and “e” and attaching the opposing edges together forms a second seam 402 (FIG. 4B) disposed along the spine on the top of the trophy 213. It will be appreciated edges may be attached to each other in any suitable manner, including stitching, heat sealing, or any suitable technique for attaching together opposing fabric edges, now known or hereafter developed.

FIG. 2A also shows a crenallated edge 206 that provides points for securing the lower edge of the body cover 101 to the back of the body form 105. The body cover 101 can also be anchored to the body form 105 using adhesives or other appropriate means. The body cover 101 can be mounted to the body form 105 permanently or temporarily to allow replacement. The body form 105 may be molded or finished to include a rough surface texture. The body cover 101 may be retained on the body form 105 with friction. The body form 105 comprises certain contours to replicate the physique of an animal and these contours can also be used to help register the body cover 101 to the body form 105. The body cover 101 is constructed such that once printed and cut, it can be applied to the body form 105 concealing a seam 209 or positioning the seam 402 on a part of the trophy 213 not normally viewed by an observer. The body cover 101 preferably comprises a flexible fabric having sufficient elasticity in order to better conform to the contours of the form 105, such fabrics including polyester and spandex.

The body cover 101 image is preferably created as a mosaic of multiple images from various views that when combined and blended, accurately mimic the hide of an actual animal. The imagery can be created in a variety of ways to include the use of actual images taken from actual animal hides or even artificially created using computer graphics. The printed images on the body cover 101 need not be limited to animal hides, but may include non-animal prints such as camouflage patterns and even sports emblems. Alternatively, a printed fur image might include embedded water-marking emblems.

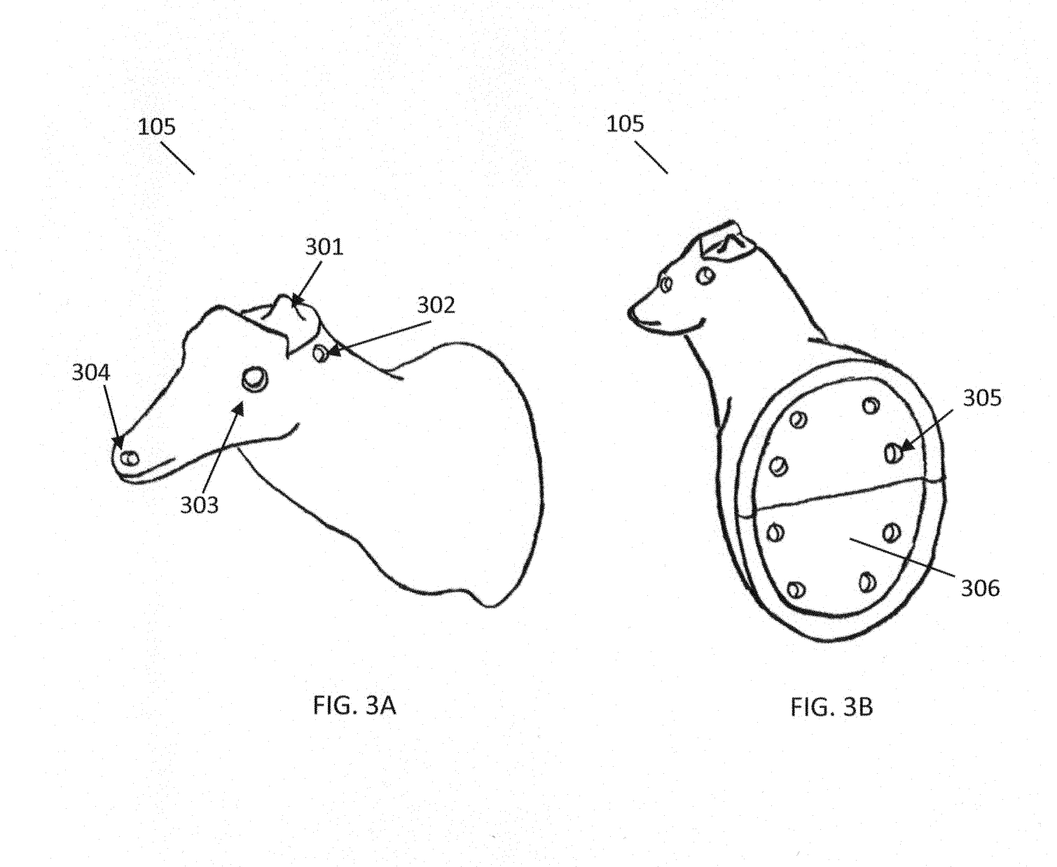

FIGS. 3A & 3B present the body form 105 in greater detail, showing structure attributes to accommodate the various components that comprise the DIY taxidermy kit. The form 105 may comprise left and right eye holes 303 in which the eye appliances 103, 104 are inserted as described below. Similarly, the form 105 may include a nose hole 304 which can host the nose appliance 102. Lastly, the form 105 may also include a pair of ear holes 302 for attachment of the ear appliances 106, 107.

The body form 105 facilitates the mounting of the antlers 110 with a hump 301 that allows the underside of the skull between the antlers to move over the hump 301 until such time that the screw(s) 111 are applied and the antlers are securely mounted to the body form 105. A plurality of holes 305 on the back side 306 of the main form 105 provides a method of anchoring the rear edge of the printed cover 101.

FIGS. 4A & 4B show front and rear views, respectively, of the fully assembled DIY taxidermy kit. Eye appliance 104 or either printed eye 201 provide a realistic looking eye. Nose appliance 102 or a printed nose 208 provide a realistic looking nose. A flap 204 extending rearward from the top of the head provides a continuous print that extends over the back of the head and between the antlers. FIG. 4(B) shows how the crenallated back edge 206 of the main cover 101 can be anchored to the back of the main form 105 by tucking fabric strips 403 of the crenallated edge 206 into corresponding holes 305 and plugging each hole with a plug 401. This prevents runs or tears in the covers that could otherwise appear if the main cover 101 is stapled to the back of the main form 105.

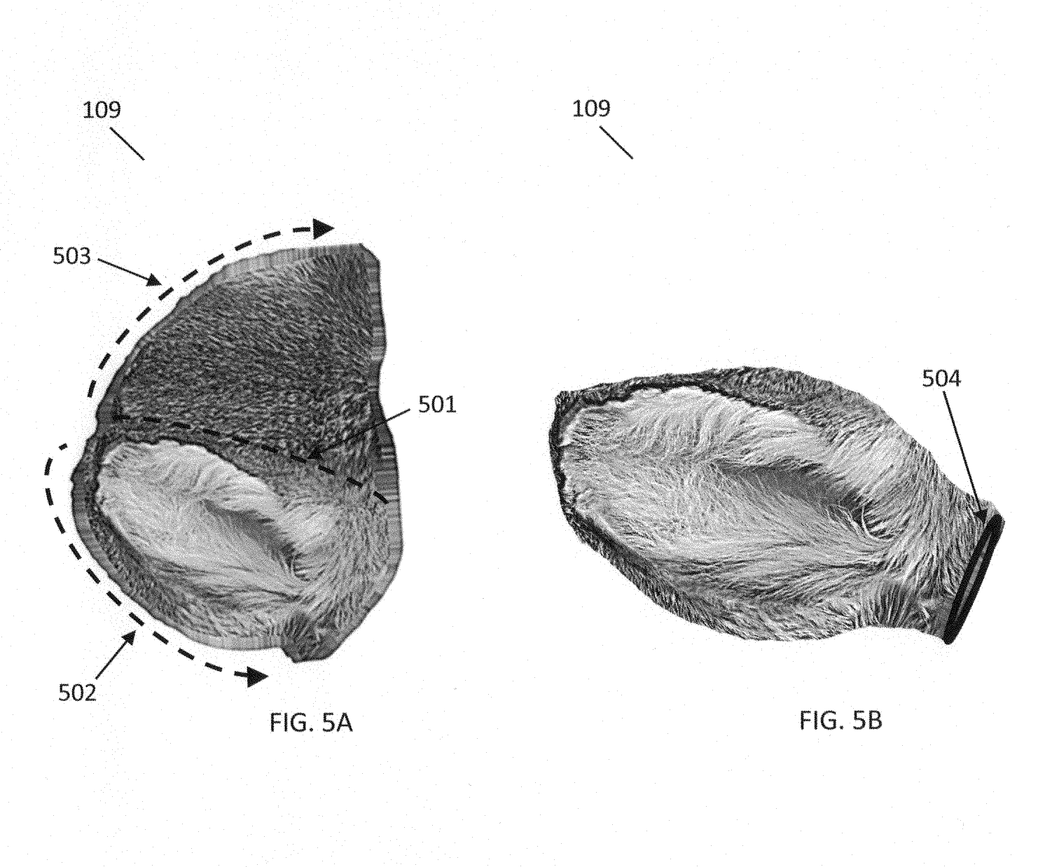

FIGS. 5A & 5B show an exemplary ear cover 108, 109 constructed from a single piece of printed fabric whereby the fabric is folded about dotted line 501, and then fastened together along dotted lines 502 & 503 thus producing a sack configuration that slides over the ear forms 106, 107 by inserting the form 106, 107 into the opening 504.

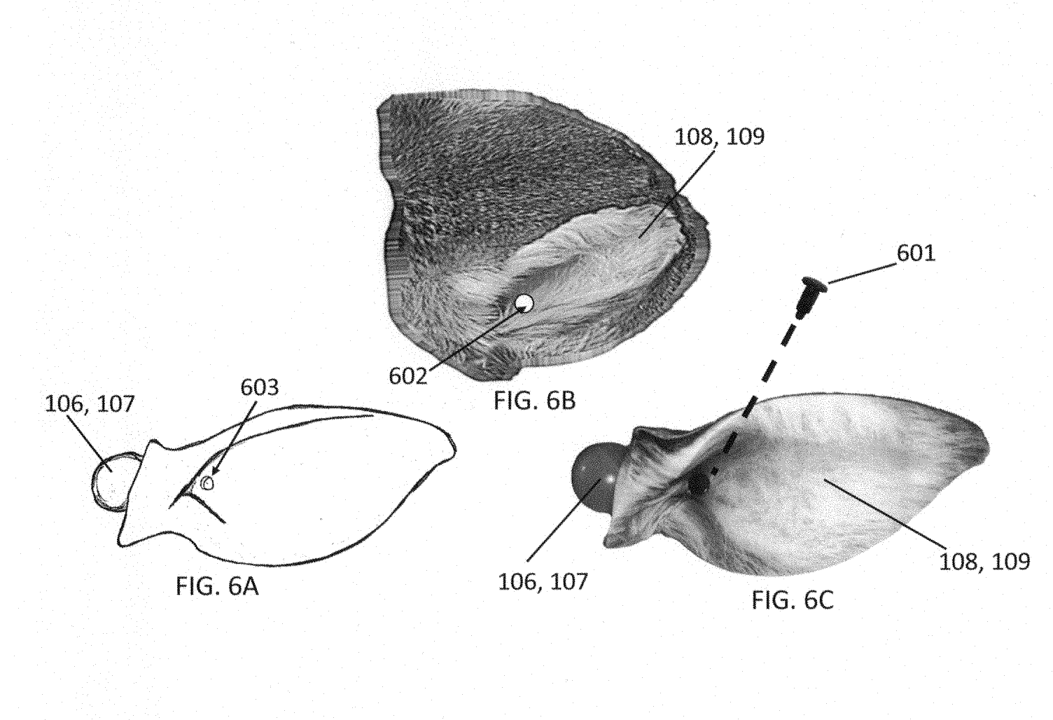

FIG. 6 shows an embodiment in which the printed ear cover 106 that can be inserted into the ear canal and secured therein with a plug 601 when installed on the ear form 106. The ear forms 106, 107 may include holes 603 disposed in the ear canals of the form. In this embodiment, the cover 108, 109 also includes a corresponding hole 602. When the cover 108, 109 is fitted over the ear form 106, 107 the hole 602 in the cover corresponds with the hole 603 in the ear form and the plug 601 may then be inserted into the two holes. This results in drawing the excess fabric of the ear cover 10, 109 into the ear canal to better mimic the appearance of an actual ear.

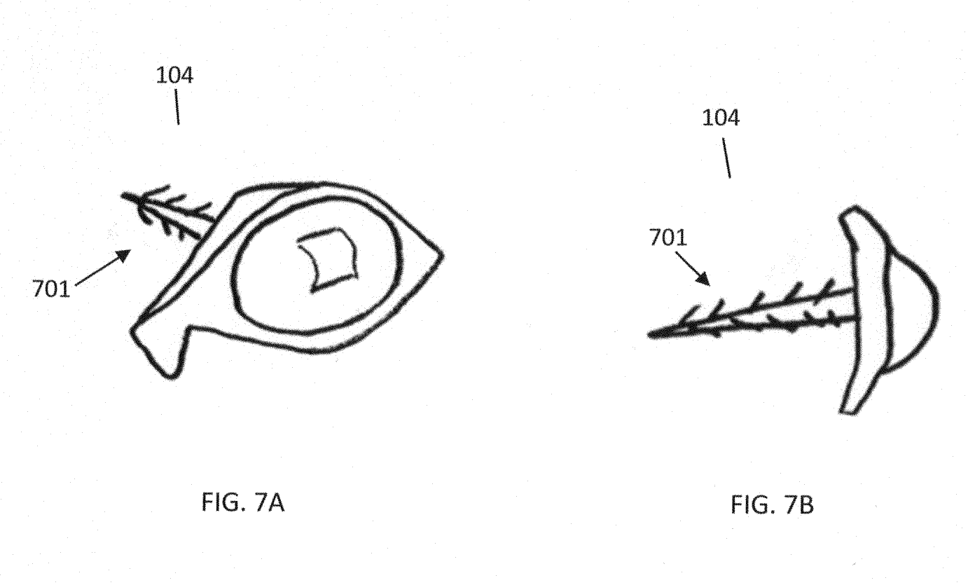

FIG. 7 shows an eye appliance 103, 104 that may be applied on top of the body cover 101 after the body cover has been applied to the body form 105. The eye appliances 103, 104 can be attached and secured in a variety of ways to include adhesives or an eye appliance barb 701 that is inserted into the body form 105 through respective eye holes 303.

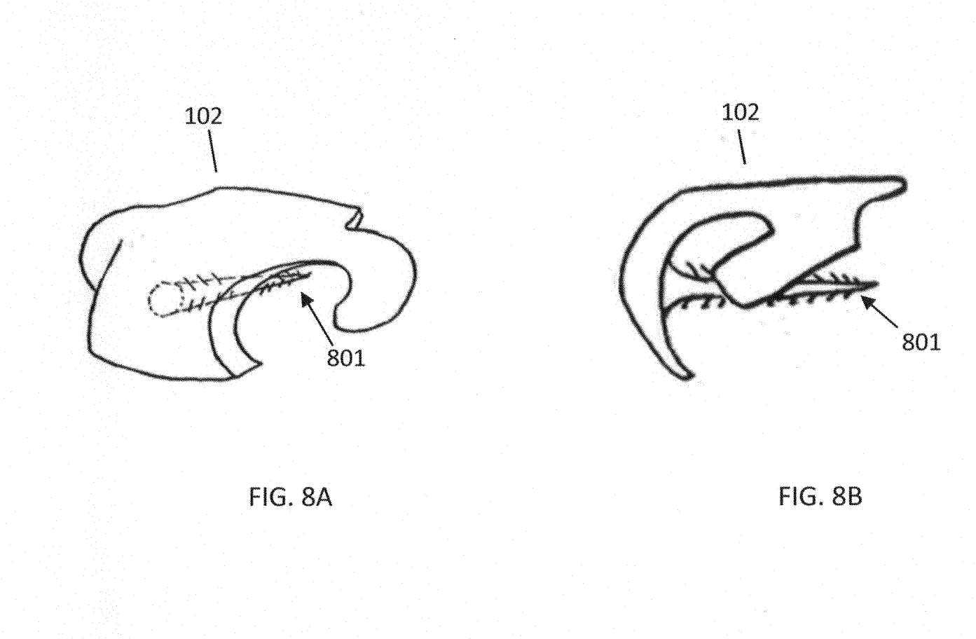

FIGS. 8A & 8B show a nose appliance 102 that is applied on top of the body cover 101 after the body cover has been applied to the body form 105. The nose appliance 102 can be attached and secured in a variety of way to include adhesives or a nose appliance barb 801 that is inserted into the body form 105 through the nose hole 304.

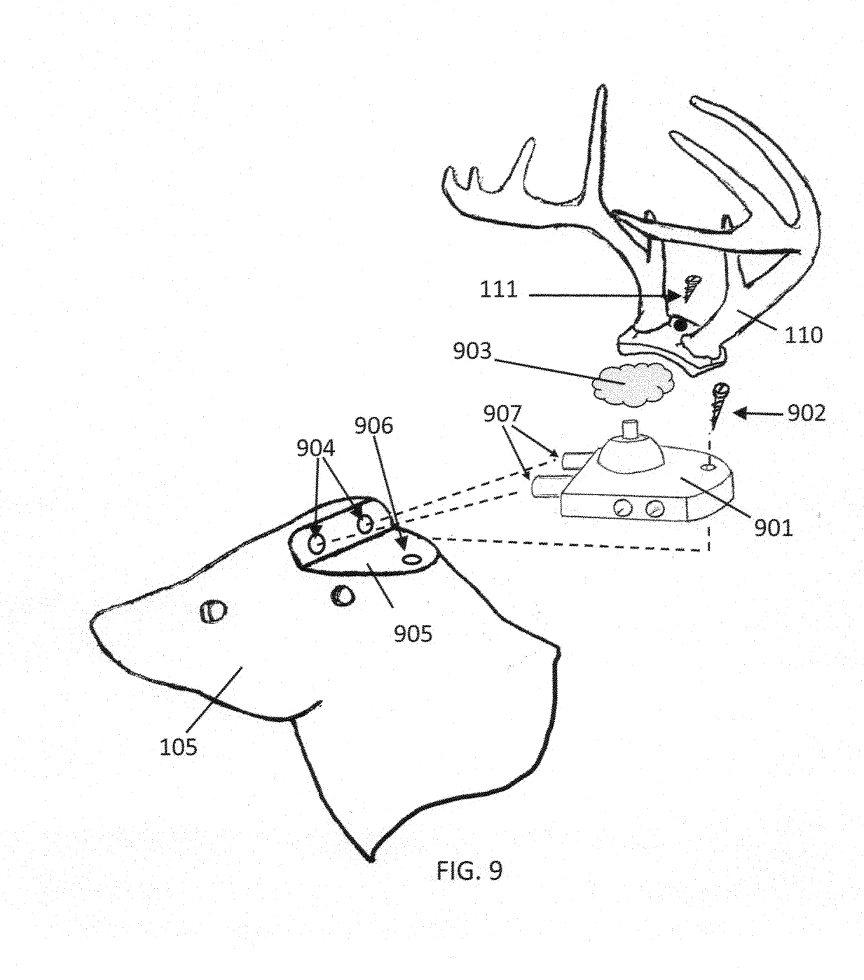

Another embodiment presented in FIG. 9 shows an alternative method for mounting the antlers 110 to the head of the form 105. In this embodiment, in place of the integrally formed hump 301 described above, a removable mounting block 301 may be provided. This block 901 allows the antlers 110 to be attached and provides an ability to easily swap out with other antlers mounted on identical mounting blocks 901. A shoulder 905 is formed on top of the head having a rearward facing wall in which is defined one or more guide holes 904 and one or more attachment holes 906 defined in the top surface near the rear of the shoulder 905. The mounting block 901 is attached to the body form 105 by inserting pegs 907 on the mounting block 901 into corresponding holes 904. A mounting screw 902 is used to secure the mounting block 901 to the rear portion of the shoulder 905 of body form 105. A fast cure epoxy or clay 903 may be used to orient and hold the antlers 110 prior to final installation of the screw(s) 111.

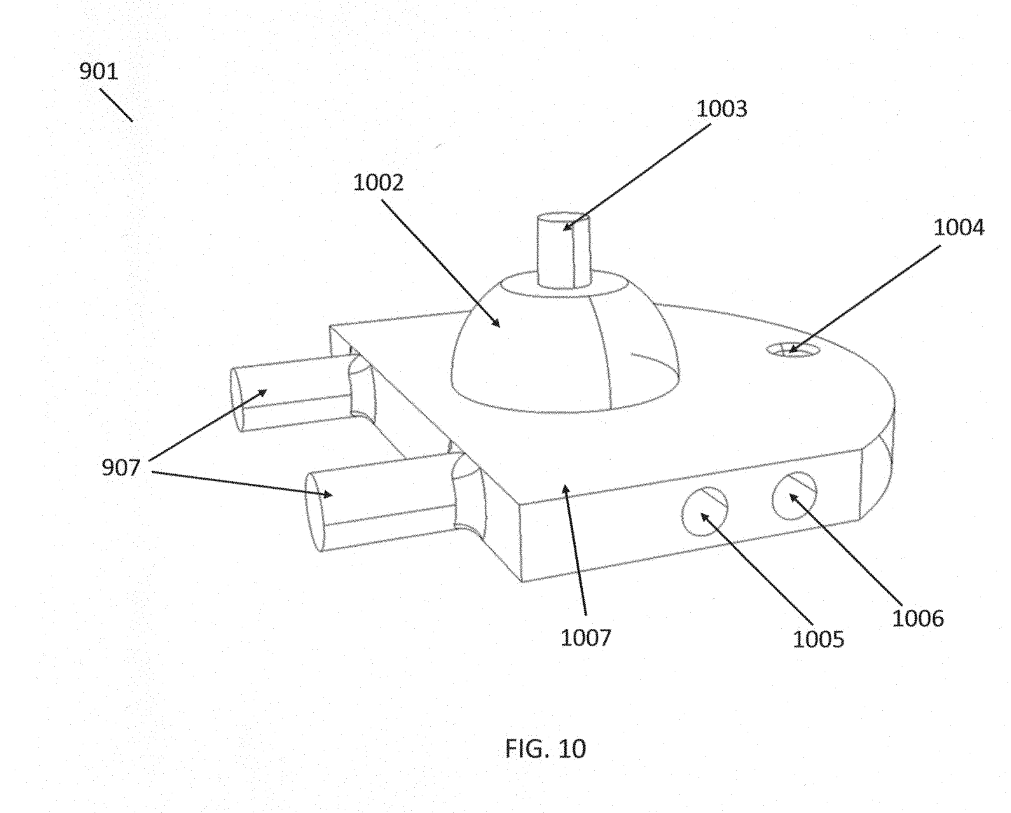

The mounting block 901 is depicted in greater detail in FIG. 10. The block 901 comprises a platform member 1007 on the top surface of which is disposed a knob 1002. The knob 1002 provides support for the skull when the skull is attached to the mounting appliance as well as a base into which attaching fasteners 111 may be installed. In a preferred embodiment, a post 1003 extends upward from the knob 1002. In such a version, the post 1003 may be trimmed down to provide a method of adjusting the height of antlers 110. One or more pegs 907 extend forward from the platform member 1007. When installing the mounting appliance on the form 105, the platform member 1007 is placed upon the shoulder 905 and urged forward until the peg(s) 907 are inserted into the guide hole(s) 904 on the main form 105. One or more attachment holes 1004 are defined through the platform member 1007 and are provided to receive a corresponding number of mounting screws 902 to secure the mounting block 901 to the main form 105 in the corresponding attachment holes 906 in the shoulder 905. Optionally, one or more apertures 1005 & 1006 may be defined in the lateral edges of the platform member to provide a means of anchoring a top covering, described below, onto the antlers 110 after the antlers 110 have been attached to the mounting block 901.

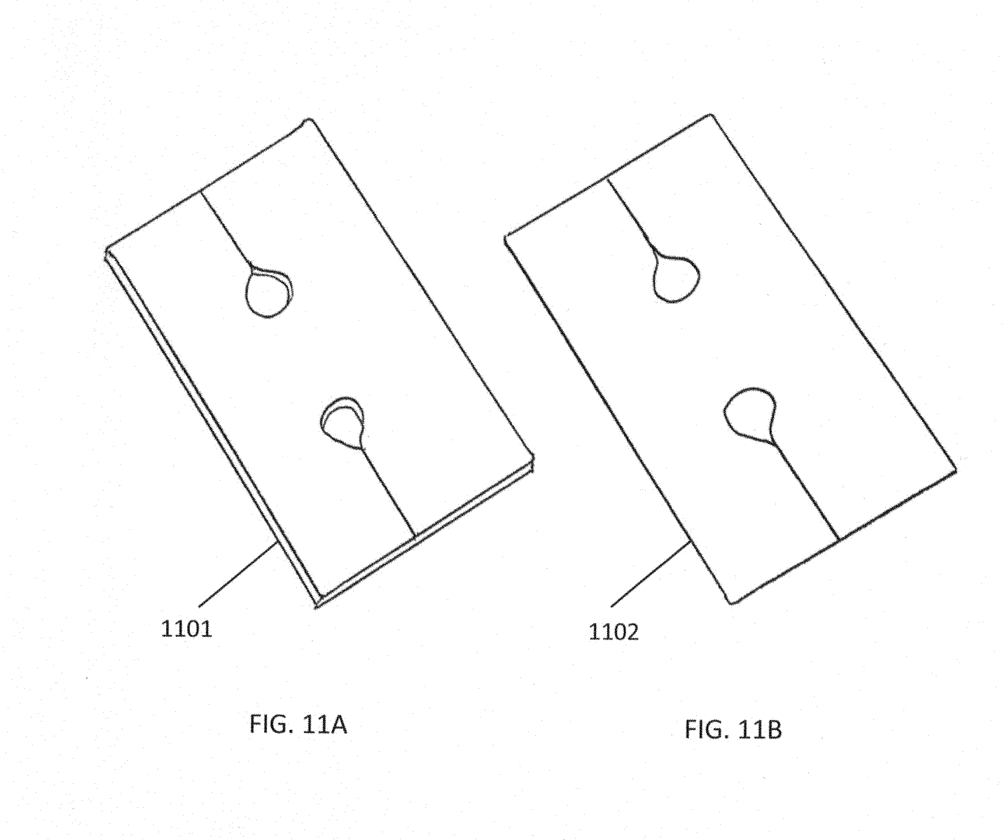

FIG. 11 shows a foam toupee 1101 and a printed toupee 1102 that are used to dress-out the antlers.

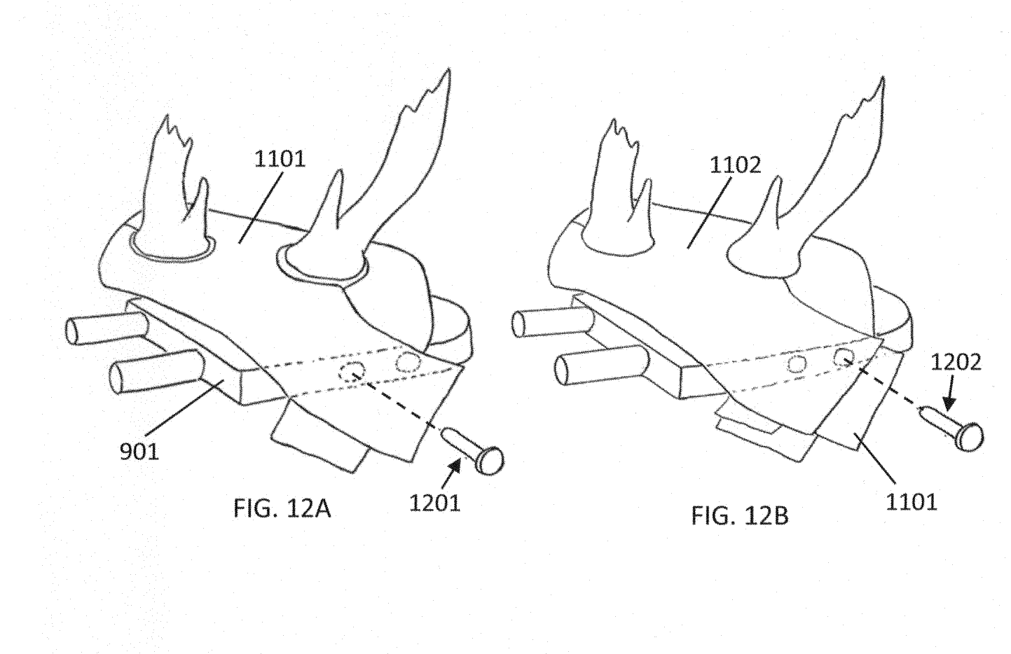

FIG. 12 shows how the foam toupee 1101 and the printed toupee 1102 are installed. A foam toupee 1101 simulating the thickness of the actual deer fur is installed first. The foam toupee 1101 is folded as shown in FIG. 12A and secured by plugging peg 1201 into hole 1005. A printed toupee 1102 is installed over the foam toupee 1101 (FIG. 12B) and carefully cut so that the printed material fits snug all the way around the base of the antlers 110. The printed toupee 1102 is secured by plugging peg 1202 into hole 1006. Once the foam toupee 1101 and the printed toupee 1102 are installed, a flap feature 204 of the main cover is pulled over the printed toupee 1102.

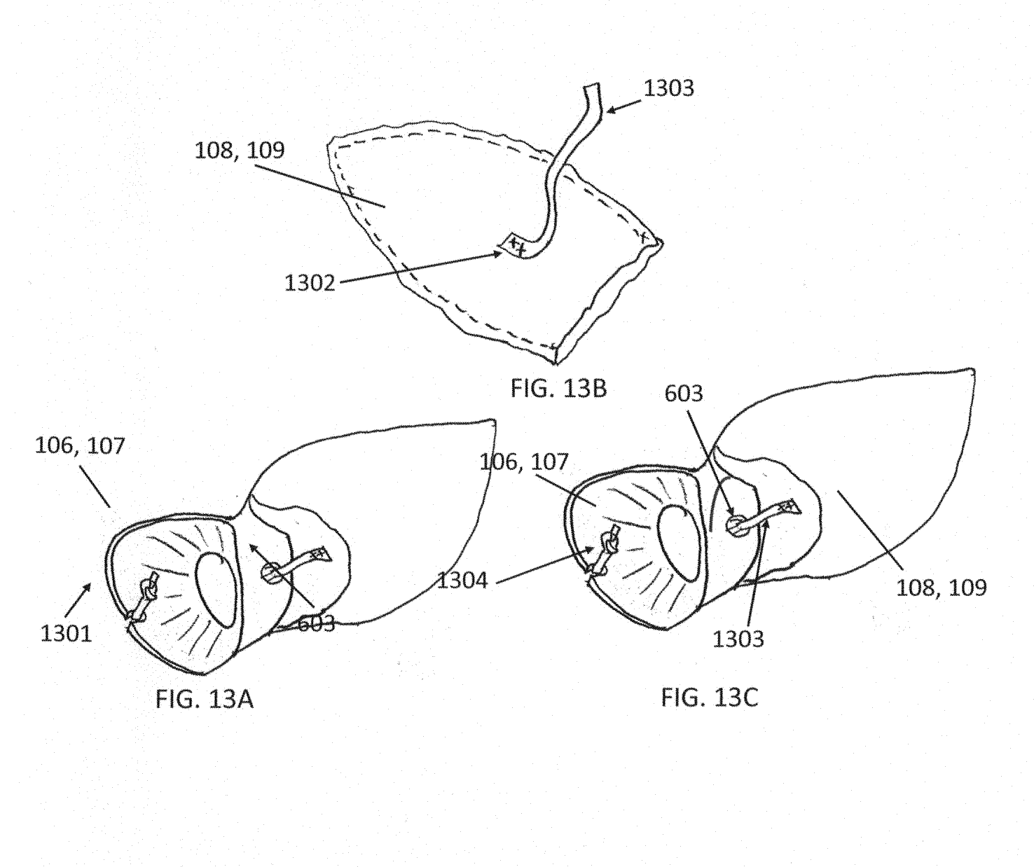

Another embodiment presented in FIGS. 13A & 13B & 13C provides an ear cover 108, 109 having a tether, or strap 1303 attached to the inside of the ear cover 108, 109. In this embodiment the ear cover 100, 109 is secured to the ear form 106, 107 by inserting the ear form into the cover and then inserting the tether 1303 through hole 603. The end of the tether 1303 is drawn through a slot 1301 formed in the base of the ear form 106, 107 and the end of the tether 1303 is knotted 1304, as shown in FIG. 13C, so that the tether end is retained in the slot 1301.

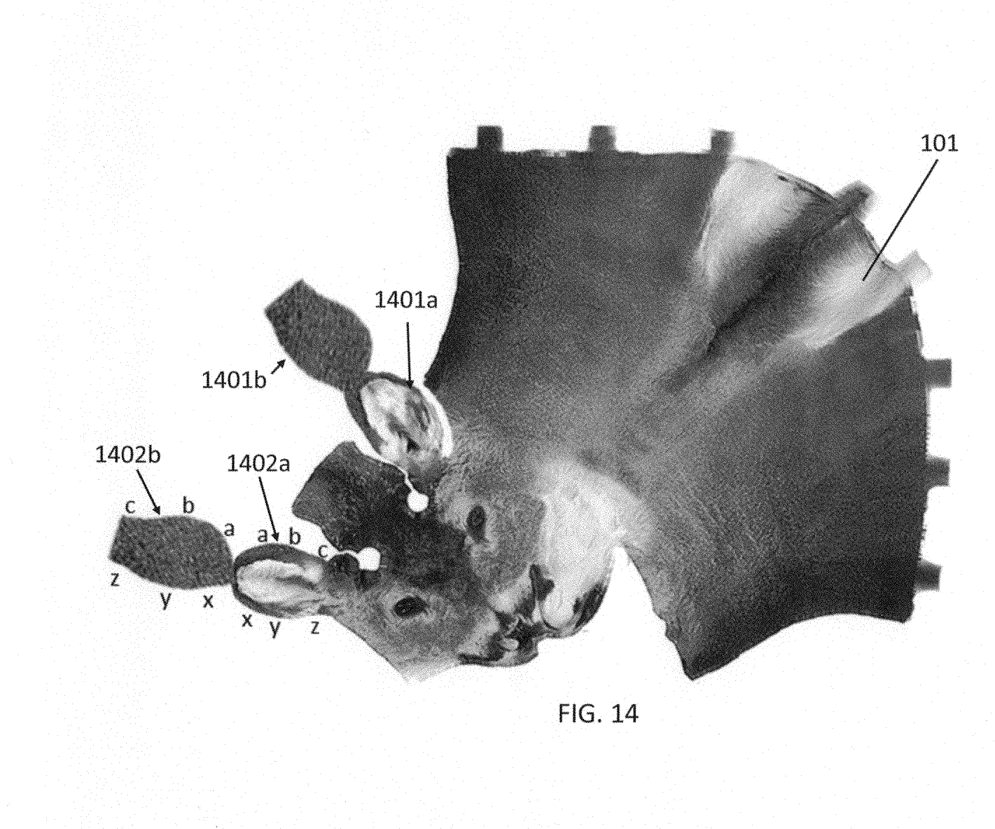

FIG. 14 shows yet another alternative embodiment of a flat pattern of the body cover 101 again comprising a photorealistic image printed on fabric as described above. In this example, however, the cover includes coverings for ears imprinted with a photorealistic image, and formed as an integral piece of the body cover 101. Accordingly, there is no need for separate ear covers 108, 109 in this embodiment. The body cover 101 may include left and right front ear cover portions 1401a, 1402a and corresponding left and right rear ear cover portions 1401b, 1402b extending therefrom. In assembly, the respective rear ear cover portions 1401b, 1402b are folded to behind the front portions 1401a, 1402a and attached at the edges in any manner described above.

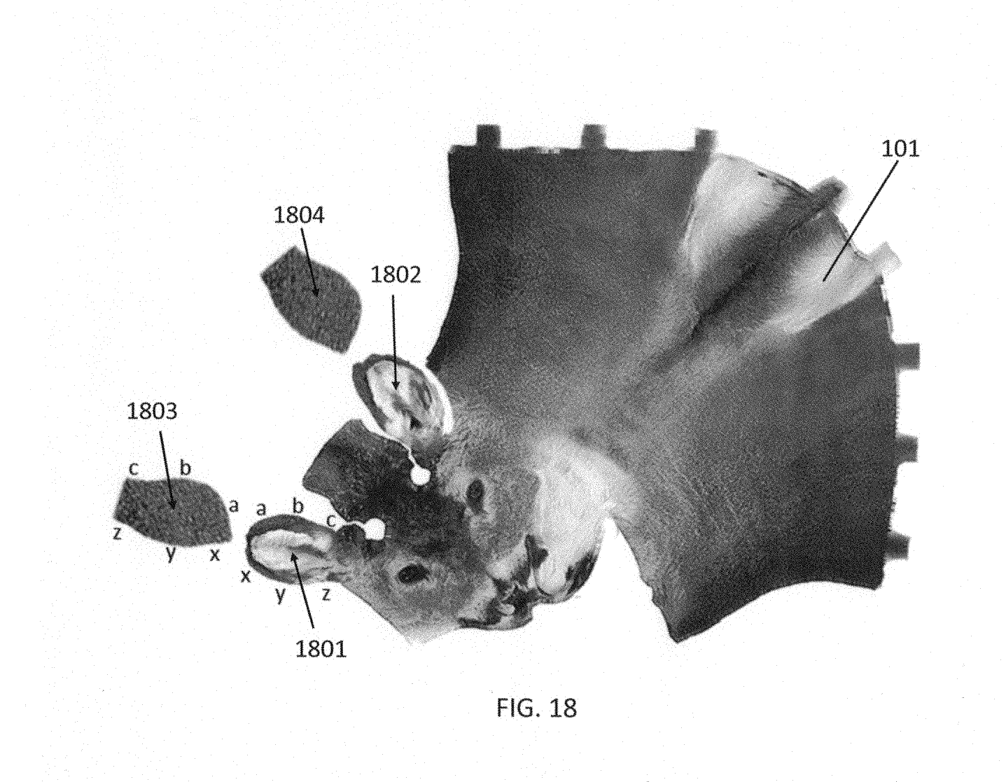

Alternatively, with reference to FIG. 18, the body cover 101 may integrally comprise only the front portion of the left and right ear coverings 1801, 1802. Corresponding rear ear cover pieces 1803, 1804 may be joined separately to the integral front ear coverings 1801, 1802 as shown, where the annotations “a”, “b”, and “c” indicate points along the inside edges of the corresponding ear cover pieces. Similarly, annotations “x”, “y”, and “z” show possible points along the outside edges of the corresponding ear cover pieces. The left and right opposing cover pieces may be mated together at those reference points, bringing opposing edges of the pieces together. The edges are fastened to one another to form a sack to slide over the ear forms 106, 107. It will be appreciated that edges may be attached to each other in any suitable manner, including stitching, heat sealing, or any suitable technique for attaching together opposing fabric edges, now known or hereafter developed.

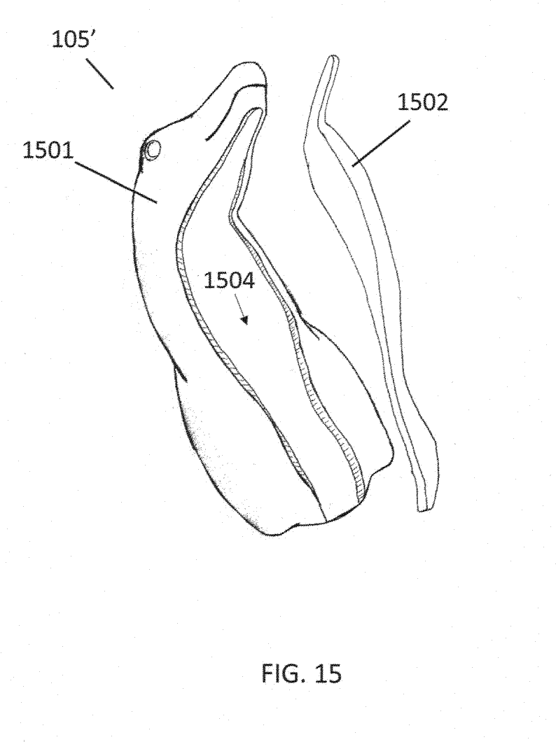

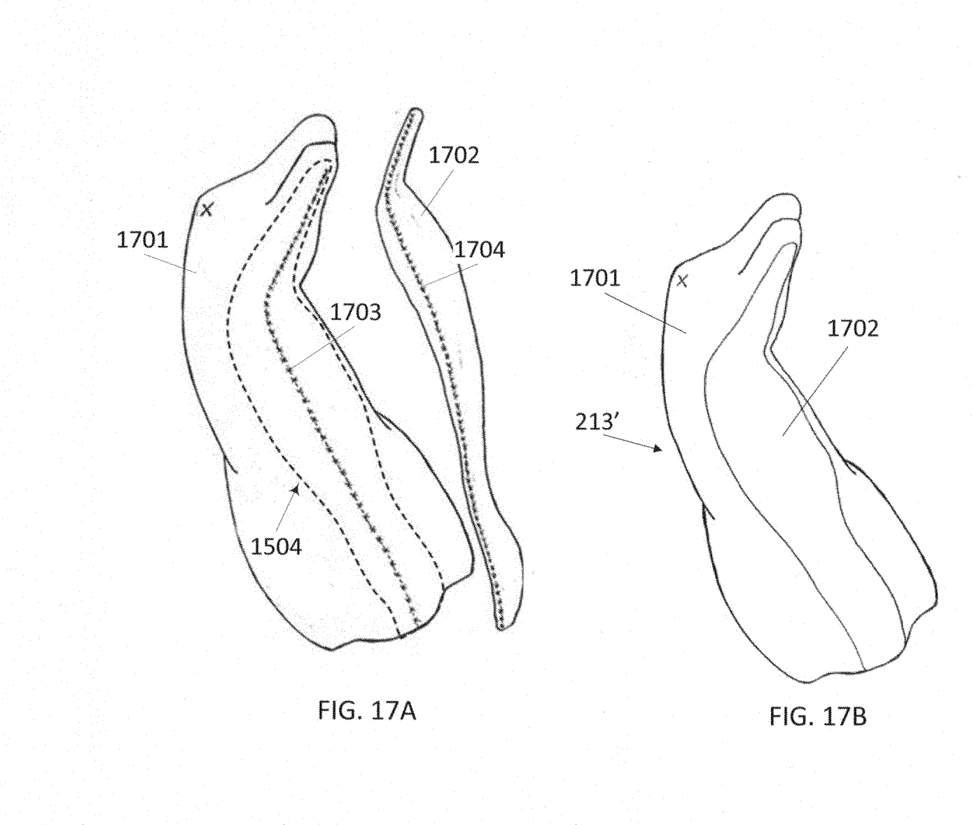

FIGS. 15 through 17 show an embodiment which employs a two-piece body form 105′ the purpose of which is to disguise seams in the fully assembled trophy 213′. The two pieces comprise an upper body form 1301 which includes the animal head and neck and is formed with an opening or depression 1504 that extends across the animal form breast. A breast plate 1502 is formed to fit snugly within the opening 1504. The two pieces are fashioned to approximate the musculature of the animal represented by the trophy 213′ (FIG. 17B). Accordingly, the edges of the opening 1504 are defined such that they would appear along the sinews of the underside of the animal's neck.

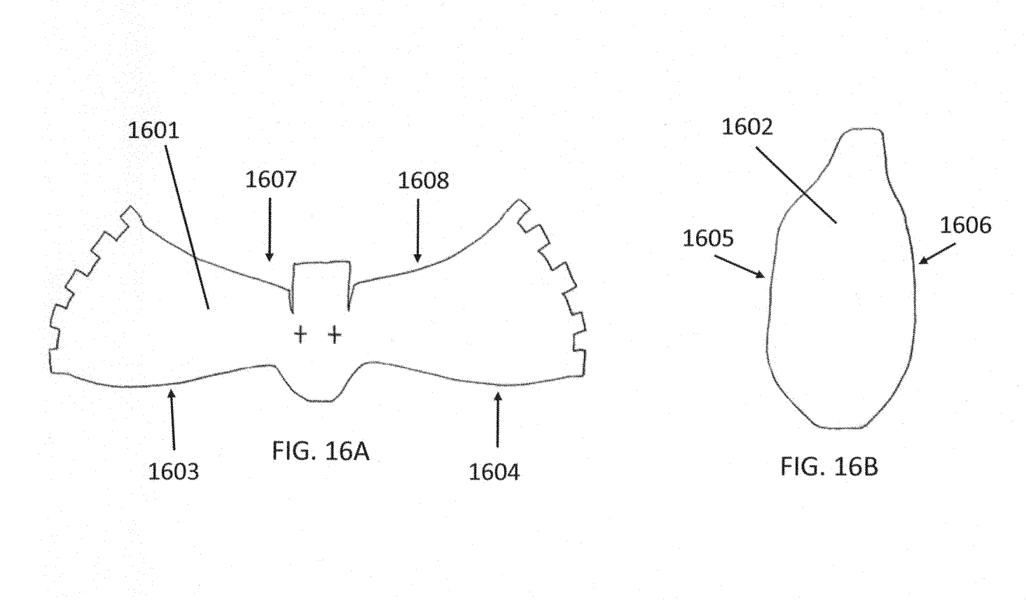

With reference to FIGS. 16A & 16B, this embodiment comprises one upper body cover 1601 and a breast plate cover 1602, both of which include a photorealistic image of the animal printed thereon and are made of the same type of fabric as the body cover 101 described above. The upper body cover 1601 is constructed to have opposing forward edges 1603, 1604 and opposing rear edges 1607, 1608. The opposing forward edges 1605, 1604 are brought together and attached to each other to form seam 1703 (FIG. 17A). The opposing rear edges 1607, 1601 are brought together to form a seam (not shown) that is virtually unnoticeable once the DIY taxidermy kit is fully assembled as it lays along the spine of the trophy 213′. It will be appreciated that edges may be attached to each other in any suitable manner, including stitching, heat sealing, or any suitable technique for attaching together opposing fabric edges, now known or hereafter developed.

In like manner, the printed breast plate cover 1602 is assembled by attaching lateral edges 1605 and 1606 to one another to form a sack having a seam 1704 (FIG. 17A) disposed near the lateral edges of the breast plate but preferably toward the interior thereof with respect to the upper body form 1501. Accordingly, care should be taken to form the breast plate cover pattern such that the finished seam 1704 lays properly.

The upper body form 1501 and the breast plate 1502 are covered in a manner similar to that described above wherein the upper body cover 1601 is assembled to form a sack into which the upper body form 1501 is inserted. Likewise, the breast plate cover 1602 is formed into a sack into which the breast plate 1502 is inserted. As shown in FIG. 17A, seam 1703 is disposed within the region of the opening 1504 now obscured by the upper body cover 1601 as indicated by the outline in dashes.

The trophy 213′ is then fully assembled by placing the covered breast plate 1702 on the underside neck portion of the covered upper body form 1701, overlaying the region of the obscured opening 1504. The lateral seam 1704 of the covered breast plate 1702 is pushed into the edges of the opening 1504. As a result, seam 1703 and seam 1704 are hidden from view. The covered breast plate 1702 is retained against the covered upper body form 1701 by simple friction, corresponding magnets, or attached thereto with suitable fasteners known in the arts. It should be borne in mind if fasteners are used to attach the covered breast plate 1702 to the covered upper body form 1701, care should be taken to do so in a way to conceal the fasteners from view when the forms are assembled together.

As described above and shown in the associated drawings, the present invention comprises a do-it-yourself taxidermy kit. While particular embodiments have been described, it will be understood, however, that any invention appertaining to the kit described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A taxidermy kit comprising:
a three-dimensional form having the shape of a partial body of an animal;
a fabric body covering imprinted with a photorealistic image of the exterior of said animal and constructed to snugly enclose said form;
left and right ear appliances attachable to said form;
left and right eye appliances attachable to said form; and
a nose appliance attachable to said form.

2. The taxidermy kit of claim 1, wherein said form is shaped to comprise head and neck portions of a deer.

3. The taxidermy kit of claim 2, further comprising means for attaching deer antlers to a top of said head portion of said form.

4. The taxidermy kit of claim 3, wherein said left and right ear appliances comprise respective left and right three-dimensional forms shaped to resemble a left and right ear, respectively.

5. The taxidermy kit of claim 4, further comprising left ear and right ear fabric coverings constructed to snugly enclose said left and right ear appliances, each said left ear and right ear fabric coverings being imprinted with a photorealistic image of the exterior of said deer's left and right ears.

6. The taxidermy kit of claim 5, wherein said body covering fabric and said left and right ear coverings are each imprinted with a photorealistic image through one of a direct-to-garment printing process, screen printing process and a sublimation printing process.

7. The taxidermy kit of claim 6, wherein said body covering and said left and right ear coverings are formed from a flexible, resilient fabric.

8. The taxidermy kit of claim 3, wherein said means for attaching said deer antlers to said head portion of said body form comprises a removable a antler mounting block configured to be attached to said head of said form and wherein said antlers are attachable to said mounting block.

9. The taxidermy kit of claim 8, wherein said mounting block further comprises a knob extending upward from a top surface of said mounting block.

10. The taxidermy kit of claim 9, further comprising a post extending upward from said knob.

11. The taxidermy kit of claim 1, wherein said body covering comprises a single piece of fabric.

12. The taxidermy kit of claim 1, wherein said photorealistic image is generated from a high resolution printing process, said process printing at a resolution in the range from about 50 DPI to about 1400 DPI.

13. The taxidermy kit of claim 12, wherein said photorealistic image is generated from a high resolution printing process, said process printing at a resolution of one of about 150 DPI, about 300 DPI, about 500 DPI and about 1200 DPI.

14. A do-it-yourself taxidermy kit for mounting a deer trophy comprising;
a body form resembling a deer head and neck;
a body covering, said body covering comprising a flexible, resilient fabric imprinted with a photorealistic image of head and neck portions of a deer hide, and wherein said body covering is constructed to snugly enclose said body form; and
means for attaching a set of deer antlers to the head of said body form.

15. The do-it-yourself taxidermy kit for mounting a deer trophy of claim 14, wherein said photorealistic image is generated from a high resolution printing process, said process printing at a resolution in the range from about 50 DPI to about 1400 DPI.

16. The do-it-yourself taxidermy kit for mounting a deer trophy of claim 15, wherein said photorealistic image is generated from a high resolution printing process, said process printing at a resolution of one of about 150 DPI, about 300 DPI, about 600 DPI and about 1200 DPI.

17. The do-it-yourself taxidermy kit of claim 14, wherein said body form is shaped to comprise left and right eye regions and a nose region, wherein said photorealistic image imprinted on said body covering comprises photorealistic left and right eyes images and photorealistic nose image, and wherein said body covering is constructed such that when said body form is enclosed in said body covering, said left and right eye images snugly overlay, respectively, said left and right eye regions and said nose image snugly overlays said nose region.

18. The do-it-yourself taxidermy kit of claim 14, wherein said body covering comprises integrally-formed left and right ear covers, said ear covers comprising photorealistic images of a deer's left and right ears.

19. The do-it-yourself taxidermy kit of claim 18, wherein said body covering comprises integrally-formed front portions of left and right ear covers, and further comprising separate corresponding rear pieces of left and right ear cover for attachment to said integrally-formed front portions.

20. The do-it-yourself taxidermy kit of claim 14, further comprising:
left and right ears attachable to said head of said body form, said left and right ears comprising respective left and right ear forms and respective left and right ear coverings, each of said left and right ear coverings comprising a flexible, resilient fabric imprinted with a photorealistic image of respective left and right ears of a deer and constructed to snugly enclose said left and right ear forms.

21. The do-it-yourself taxidermy kit of claim 20, further comprising:
a nose appliance resembling a deer nose and attachable to said body form.

22. The do-it-yourself taxidermy kit of claim 20, wherein said body form is shaped to comprise left and right eye regions and a nose region, wherein said photorealistic image imprinted on said body covering comprises photorealistic left and right eyes images and photorealistic nose image, and wherein said body covering is constructed such that when said body form is enclosed in said body covering, said left and right eye images snugly overlay, respectively, said left and right eye regions and said nose image snugly overlays said nose region.

23. The do-it-yourself taxidermy kit of claim 14, wherein said means for attaching said antlers comprises a mounting block removably attachable to said body form head and comprising a support knob extending upward from the top of said block for supporting the base of said antlers.

24. The do-it-yourself taxidermy kit of claim 23, further comprising a post extending upward from said knob.

25. The do-it-yourself taxidermy kit of claim 14, wherein said body covering is formed to comprise a flap configured such that when said body form is enclosed in said body covering, said flap extends rearward over the head of the form.
